(19) United States
(12) Patent Application Publication
(10) Pub. No.: US 2018/0222089 A1
(43) Pub. Date: Aug. 9, 2018

(54) SURFACE TREATMENT METHOD FOR TRANSPARENT RESIN FORMING MOLD, TRANSPARENT RESIN FORMING MOLD, AND TRANSPARENT RESIN FORMED ARTICLE

(71) Applicant: FUJI MANUFACTURING CO., LTD., Tokyo (JP)

(72) Inventors: Keiji MASE, Tokyo (JP); Shozo ISHIBASHI, Tokyo (JP); Yusuke KONDO, Tokyo (JP)

(21) Appl. No.: 15/750,676

(22) PCT Filed: Aug. 11, 2015
(86) PCT No.: PCT/JP2015/072794

§ 371 Date: Feb. 6, 2018

(51) Int. Cl. B29C 33/42; B22C 9/18; B24C 1/06; B24C 1/10

(52) U.S. Cl. CPC B29C 33/424; B22C 9/18; B29C 33/442; B24C 1/10; B24C 1/06

(57) ABSTRACT

A method of treating a surface of a mold for transparent resin molding. The method includes ejecting substantially spherical ejection particles against a surface of a mold employed to mold a transparent resin so as to bombard the surface. The method includes forming dimples with an equivalent diameter in a range that satisfies a condition defined by the following formula:

1+3.3e^{-H/230}≤W≤1.5+8.9e^{-H/630}

wherein W is an equivalent diameter (μm) of the dimples and H is a base metal hardness (Hv) of the mold.

### TECHNICAL FIELD

The present invention relates to a method of treating a surface of a mold for molding transparent resin, to a mold for molding transparent resin having a surface treated by this method, and to a transparent resin molded article molded by the mold. More particularly, the present invention relates to a mold surface treatment method applicable to treating a surface of a mold employed to manufacture a transparent resin molded article, to a mold having a surface treated by this method, and to a transparent resin molded article molded by employing this mold.

Note that in the present invention, a surface of a mold subject to treatment refers to a surface of a portion that contacts molding material.

### BACKGROUND OF THE INVENTION

Transparent resin molded articles obtained by molding a molding material formed from a transparent resin are widely employed in optical products, medical implements, electrical products, household goods, toys, and various other fields.

When molding such transparent resins, even if molding is performed using molding materials with a high transparency, transparency is lost due to diffuse reflection of light from surfaces of the molded articles if there is a lack of smoothness due to fine irregularities being formed on the surfaces of the molded articles.

Thus, so as not to form irregularities on the surfaces of transparent resin molded articles, the surfaces of molds employed to mold transparent resins are finished at high precision to a mirror finish, by polishing by hand or the like. Finishing the surfaces of molded articles to a smooth finish thereby enables transparency to be imparted to the resin molded articles obtained.

However, along with molds having increasingly complex shapes, there is now a demand for shorter lead times for mold deliveries. The polishing of surfaces of molds to a mirror finish by hand, which is both labor intensive and time consuming, is an impediment to meeting such demands, and causes an increase in mold fabrication costs.

Moreover, sometimes the contact resistance between the surface of the molded article and the mold surface during demolding increases, with a reduction in demoldability, when mold surfaces are polished to a mirror finish.

Such a reduction in demoldability means that a large force needs to be applied when removing formed molded articles from the mold. This results in an increase in the molded articles showing deformation and damage, and a rise in the rate of defects.

Thus, various methods have been proposed to improve the demoldability of workpieces. For example, there is a proposal to increase the draft angle provided to cavities of molds, and there is moreover a proposal to perform surface treatment to enhance the slipperiness of surfaces of molds, e.g. by forming a fluorine based coating or a diamond-like carbon (DLC) film.

Furthermore, as a treatment to improve the demoldability, in contrast to making surfaces of molds smooth surfaces, there is also a proposal to form irregularities of a predetermined shape thereon. An example of this is a proposal for a “method of treating the surface of a cavity of a die used for casting” to improve fluidity while maintaining good release properties. In this proposal, spherical ejection particles of 100 to 1000 μm that have a hardness at least as hard as a casting mold are ejected against cavity surfaces of a casting mold to form semi-spherical dimples thereon (see claim 1 and claim 2 of Patent Document 1).

### RELATED ARTS

### Patent Documents

Patent Document 1: Japanese Patent No. 4655169

### SUMMARY OF THE INVENTION

### Problem to be Solved by the Invention

From out of the methods described above for improving demoldability, a method in which the draft angle is increased is a configuration that may be adopted for molds for molding transparent resins. In such a configuration, there is a need to design the shape of the molded article so as to have a larger draft angle, and this imposes a limitation to the design of molded articles.

However, such a problem of limitation to the design in such cases due to increasing the draft angle does not arise in a method to improve demoldability by using a surface coating, such as a fluorine based coating or a DLC film. However, such a method has the disadvantage of a comparatively short service life of molds due to a loss of demoldability when the coating layer is lost through abrasion or peeling off.

In contrast thereto, with a mold formed with dimples by the method described in Patent Document 1 cited above, the contact surface area between the surface of the molded article and the mold surface is reduced due to forming the dimples, and the demoldability is improved due to release agent and air pooling inside the dimples. Good demoldability is accordingly exhibited where the dimples are present on the mold surface, and good demoldability is exhibited over a comparatively long period of time in comparison with a case when employing a surface coating that loses its effect through abrasion or peeling off.

Moreover, in such a method, surface treatment of the mold can be performed by a comparatively simple operation of employing a blasting apparatus to eject spherical ejection particles so as to bombard surfaces of the mold. This accordingly enables molds to be fabricated at a comparatively low cost and with comparatively short delivery lead times compared to when mold surfaces are finished to a smooth surface by polishing or the like, or compared to when a subsequent further operation of surface coating is performed.

However, when transparent resin is molded even with a mold formed with dimples on the surface by the method of Patent Document 1, irregularities are formed on the surface of the resin molded articles obtained due to transfer from the dimples formed to the mold. A transparent resin molded article is accordingly not obtainable thereby.

As a result, although the surface treatment method described above, in which dimples are formed on the surface of a mold by ejecting spherical ejection particles in the manner described above, can be thought of as being a surface treatment method capable of obtaining a mold surface exhibiting good demoldability by a comparatively simple surface treatment method, it is not a method applicable to surface treatment of molds for transparent resin molding.

Were it to be possible to obtain transparent resin molded articles using a mold subjected to such surface treatment, then it would be possible to eliminate polishing to a mirror finish from the processes necessary to fabricate molds for transparent resin molding. This would enable molds for transparent resin molding to be fabricated with shorter delivery lead times and lower cost.

The inventors of the present invention have accordingly re-investigated in some detail the reasons for not being able to obtain transparent resin molded articles using the surface treatment method described above in which dimples are formed on a mold surface. As a result, the inventors have reached the conclusion that the manufacture of transparent resin molded articles should be possible even when surface treatment is performed to form dimples on a mold surface, and this should be possible by limiting the diameters and depths of the dimples formed to predetermined ranges, so as to form dimples that are comparatively small and shallow.

Namely, in the method described in Patent Document 1 referred to above, both the diameters and depths of the dimples formed are large due to ejecting ejection particles of comparatively large particle diameter, i.e. from 100 μm to 1000 μm. As a result, irregularities formed on the surface of resin molded article due to transfer from these dimples are also large.

Moreover, when forming the dimples, at the mold surface at positions bombarded by the ejection particles, the mold base metal is pushed out by plastic flow to an extent that depends on the diameters and depths of the dimples formed, as illustrated in FIG. 1. The pushed out mold base metal forms projections that have a raised shape at peripheral edge portions of the dimples.

When molding, these projections accordingly bite into the material of the mold and are transferred to the surface of the molded articles. When the molded articles are being extracted, these projections form innumerable scratches on the surface of the molded articles, forming even more irregularities on the surface of the molded articles, and resulting in a loss of transparency.

Thus, by making the diameters and depths of the dimples formed on the mold surface smaller, the irregularities formed on the surface of the molded articles due to transfer from the dimples can also be made small. In addition, the extent to which the mold base metal is pushed out by plastic flow during bombardment with the ejection particles can be lessened. As a result, it is predicted that the generation of the raised projections described above will be suppressed, preventing the generation of irregularities that accompany the transfer of such projections, preventing scratching caused by these projections, and thereby enabling an improvement to be achieved in the transparency of the molded articles obtained.

Following such a prediction, multiple molds were fabricated that had dimples of different diameters and depths formed on their surfaces by changing combinations of material of the mold treated, the material and particle diameter of the ejection particles employed, the type and ejection pressure of the blasting apparatus employed, and the like. As a result of molding transparent resin while employing such molds, it was confirmed that when comparatively small and shallow dimples formed not exceeding predetermined diameters and predetermined depths, it is possible to impart resin molded articles obtained with an equivalent transparency of molds which are adjusted so as to be smooth by polishing.

Moreover, the test results referred to above indicated the presence of an unexpected relationship in which the diameter and depth of dimples that were able to impart transparency in this manner varying according to changes in the base metal hardness of the mold. These results confirmed that transparency could not be imparted simply by making the diameters and depths of the dimples smaller, and that dimples need to be formed with appropriate diameters and depths based on the relationship to the base metal hardness of the mold.

The present invention is based on the discovery by the inventors of the present invention obtained from the test results referred to above. An object of the present invention is, in surface treatment methods to form dimples on a surface of a mold by ejecting spherical ejection particles, to clarify the formation conditions of the dimples that are capable of imparting transparency to resin molded articles molded by employing a mold that has been subjected to such surface treatment. This thereby enables a mold for transparent resin molding that does not need to be polished to a mirror finish, which is a treatment that hitherto needed to be performed on molds for transparent resin molding, and that has a short delivery lead time and low cost, to be provided, and enables a surface treatment method capable of improving the demoldability of a mold for transparent resin molding to be provided.

### Means for Solving the Problems

In order to achieve the above objects, a method of treating a surface of a mold for transparent resin molding according to the present invention comprises:

ejecting substantially spherical ejection particles against a surface of a mold employed to mold a transparent resin so as to bombard the surface; and

forming dimples with a diameter (equivalent diameter W) in a range that satisfies a condition defined by the following formula:

1+3.3e^{-H/230}≤W≤1.5+8.9e^{-H/630} Formula (1)

wherein W is an equivalent diameter (μm) of the dimples and H is a base metal hardness (Hv) of the mold.

The “equivalent diameter” here refers to the diameter of a circle determined by converting the projected surface area of a dimple formed on a molding surface to a circular projected surface area.

Preferably, the dimples are formed with a depth (D) in a range satisfying a condition defined by the following formula:

0.01+0.2e^{-H/230}≤D≤0.05+0.4e^{-H/320} Formula (2)

wherein D is a depth (μm) of the dimples and H is a hardness of mold base metal (Hv).

The method of treating a surface of a mold for transparent resin molding can be performed by which the dimples are formed by ejecting the ejection particles having a median diameter not greater than 20 μm at an ejection pressure of from 0.01 MPa to 0.6 MPa such that a surface area formed with the dimples is not less than 50% of a surface area of the mold surface.

Note that the “median diameter” refers to a particle diameter that when employed to divide a group of particles into two, results in the integral volume of particles in the group of particles of larger diameter being the same volume as the integral volume of particles in the group of particles of smaller diameter.

Preferably, the ejection particles are ejected against a surface of a mold having a surface roughness adjusted to an Ra of 0.3 μm or less.

Furthermore, a mold for transparent resin molding according to the present invention covers a mold for transparent resin molding that has been surface treated with any of the above described methods.

Furthermore, a transparent resin molded article according to the present invention covers a transparent resin molded article molded with a mold for transparent resin that has been surface treated with any of the above methods.

### Effect of the Invention

The configuration of the present invention as described above enables the following significant advantageous effects to be obtained for a mold for molding transparent resin that has a surface treated by the surface treatment method of the present invention.

In a comparatively simple configuration, substantially spherical ejection particles are ejected against the surface of a mold to be employed for molding a transparent resin, so as to bombard the surface and form dimples of a predetermined diameter, or so as to form dimples of a predetermined diameter and predetermined depth. Adopting such a configuration enables transparency to be imparted to resin molded articles obtained by employing molds that have been subjected to such surface treatment.

Namely, by forming dimples in this manner so as to be comparatively small in both diameter and depth, an irregularities formed during molding on the surface of the transparent resin molded articles by transfer from the dimples are also small. In addition, forming dimples that are comparatively small results in a lesser extent of the mold base metal being pushed out by plastic flow at the positions bombarded by the ejection particles. This enables the formation of raised projections at peripheral edge portions of the dimples to be prevented. This is thought to enable transparency to be imparted to resin molded articles being manufactured, while still being a configuration in which dimples are formed on the mold surface.

Thus, by enabling surface finishing of a mold for transparent resin molding to be performed by a comparatively simple treatment in which the ejection particles are ejected, the need to treat the mold for transparent resin molding by polishing to a mirror finish, which has hitherto been required, is eliminated. This results in a great reduction being achieved in the time and fabrication cost required to fabricate a mold for transparent resin molding.

Moreover, due to molds formed with the dimples described above exhibiting excellent demoldability compared to molds polished to a mirror finish, there is no need to apply a large force to molded articles when demolding, preventing deformation and damage to the molded articles, and enabling the rate of defects to be reduced.

Formation of the dimples is performed by ejecting ejection particles having a median diameter not exceeding 20 μm at an ejection pressure of from 0.01 MPa to 0.6 MPa, and forming the dimples such that the dimple-formed surface area is not less than 50% of the surface area of the mold surface. This enables the formation of the projections described above on the mold surface to be appropriately suppressed, and also enables the surface hardness of the mold after dimple formation to be raised in comparison to cases in which dimples are formed using comparatively large diameter ejection particles (see FIG. 2).

As a result, stress concentration that might arise when projections are generated does not occur, and the surface hardness of the mold is raised. This not only improves the transparency of the transparent resin molded articles obtained and the demoldability, but also improves the durability and resistance to abrasion of the mold. In addition, an ideal diameter and depth of the dimples formed on the surface of the mold can be maintained over a long period of time. This enables the advantageous effects of the surface treatment, which are the exhibiting of transparency and demoldability, to be exhibited over a longer period of time.

Moreover, due to the surface treatment described above being performed on a surface of a mold adjusted to a surface roughness (arithmetic average roughness) Ra of 0.3 μm or less, a more preferable surface state can be imparted to the mold.

### BRIEF DESCRIPTION OF DRAWINGS

FIG. 1 is a diagram to explain projections arising on a mold surface accompanying the formation of dimples.

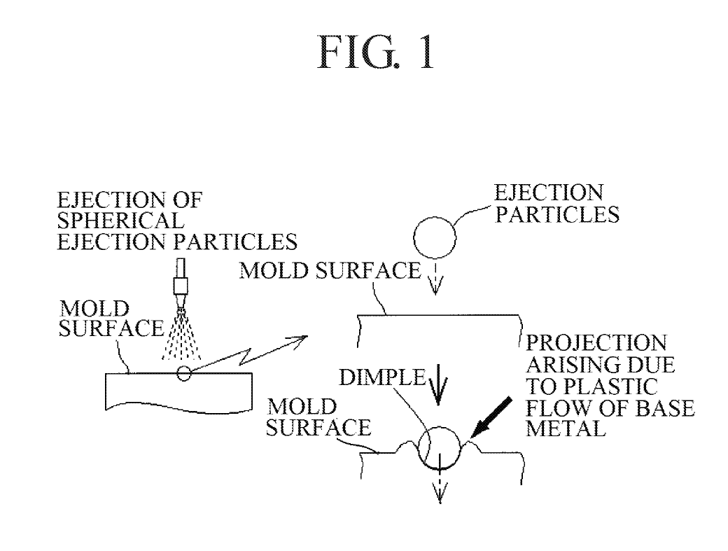

FIG. 2 is a diagram correlating ejection pressure and dynamic hardness.

FIG. 3 is a scatter plot of dimple equivalent diameter against hardness of mold base metal for Samples 1 to 22.

FIG. 4 is a scatter plot of dimple depth against hardness of mold base metal for Samples 1 to 22.

### DESCRIPTION OF EMBODIMENTS

Next, explanation follows regarding exemplary embodiments of the present invention, with reference to the accompanying drawings.

Object to be Treated

The surface treatment method of the present invention may be applied to molds for transparent resin molding. For such molds, the surface treatment method is applicable to various types of mold irrespective of the type of mold, such as molds for injection molding, molds for extrusion molding, and molds for blow molding. Moreover, as long as the material of the transparent resin molding matter to be subjected to molding by such a mold is a transparent resin, the surface treatment method is applicable to molds for molding various molding matter, such as acrylic, Nylon, vinyl chloride, polycarbonate, PET, and POM.

The surfaces of portions within such molds that make contact with the molding material may serve as a surface to be treated by the surface treatment method of the present invention. Both surfaces on a cavity (concave mold) side and a core (convex mold) side can be subjected to treatment by the method of the present invention when the mold is configured by a combination of both a cavity (concave mold) and a core (convex mold).

There are no particular limitations to the material of the mold, and various materials employed as materials for molds may be subjected to treatment. As well as ferrous metals, molds of non-ferrous metals such as aluminum alloys and the like may also be subjected to treatment.

Note that the surface roughness of the surface of a mold is preferably adjusted in advance to an arithmetic average roughness (Ra) of 0.3 μm or less prior to ejecting spherical ejection particles as described later.

Dimple Forming

Dimples are formed on the surface of a mold as described above by ejecting substantially spherical ejection particles so as to bombard the surface of molding faces of the mold.

The following are examples of ejection particles, ejection apparatuses, and ejection conditions employed to form such dimples.

(1) Ejection Particles

For the substantially spherical ejection particles employed in the method of the present invention, “substantially spherical” means that they do not need to be strictly “spherical”, and ordinary “shot” may be employed therefor. Particles of any non-angular shape, such as an elliptical shape and a barrel shape, are included in “substantially spherical ejection particles” employed in the present invention.

Materials employable as the ejection particles include both metal-based and ceramic-based materials. Examples of materials for metal-based ejection particles include steel alloys, cast iron, high-speed tool steels (HSS) (SKH), tungsten (W), stainless steels (SUS), and the like. Examples of materials for ceramic-based ejection particles include alumina (Al₂O₃), zirconia (ZrO₂), zircon (ZrSiO₄), hard glass, glass, silicon carbide (SiC), and the like. The ejection particles employed are preferably ejection particles of a material having a hardness at least equivalent to that of the base metal of the mold to be treated.

Regarding the particle diameter of the ejection particles employed, particles having a median diameter (D₅₀) in a range of from 1 μm to 20 μm may be employed. From among ejection particles of these particle diameters, the particles employed are selected so as to be able to form the dimples of the diameter and depth described below in accordance with the material and the like of the mold to be treated.

(2) Ejection Apparatus

A known blasting apparatus for ejecting compressed gas and abrasive may be employed as the ejection apparatus to eject the ejection particles described above against the surface of the mold.

Such blasting apparatuses are commercially available, such as a suction type blasting apparatus that ejects abrasive using a negative pressure generated by ejecting compressed gas, a gravity type blasting apparatus that causes abrasive falling from an abrasive tank to be carried and ejected by compressed gas, a direct pressure type blasting apparatus in which compressed gas is introduced into a tank filled with abrasive and the abrasive is ejected by merging the abrasive flow from the abrasive tank with a compressed gas flow from a separately provided compressed gas supply source, and a blower type blasting apparatus that carries and ejects the compressed gas flow from a direct pressure type blasting apparatus with a gas flow generated by a blower unit. Any one of the above may be employed to eject the ejection particles described above.

(3) Treatment Conditions

Ejection particles may be ejected using a blasting apparatus described above, for example, with an ejection pressure in the range of from 0.01 MPa to 0.6 MPa, and preferably from 0.05 MPa to 0.2 MPa, and performed such that the dimple-formed surface area (projected surface area) of the portion subjected to treatment is 50% or more of the surface area of the mold surface.

When the ejection particles are ejected, a combination of material and particle diameter for the ejection particles, and type, ejection pressure, and the like of the blasting apparatus employed, is selected in relation to the material, etc., of the mold to be treated so as to be able to form dimples of a equivalent diameter (W) found according to Formula (1), given below.

1+3.3e^{-H/230}≤W≤1.5+8.9e^{-H/630} Formula (1)

In Formula (1) above, W is the dimple equivalent diameter (μm), and H is the base metal hardness (Hv).

When the ejection particles are ejected, in addition a combination of conditions is preferably employed that also enable dimples to be formed at a dimple depth (D) found according to Formula (2), given below.

0.01+0.2e^{-H/230}≤D≤0.05+0.4e^{-H/320} Formula (2)

In Formula (2), D is the dimple depth (μm), and H is the base metal hardness (Hv).

(4) Operation Etc.

A mold subjected to surface treatment by the surface treatment method of the present invention as described above is confirmed to be able to impart transparency to transparent resin molded articles obtained. The examples described below confirm that such a mold is able to impart an equivalent degree of transparency to that of a mold (polished object) finished smooth by polishing, for example.

Such an improvement in transparency is thought to arise for the following reasons. Due to the dimples formed by the method of the present invention having the equivalent diameter and depth of the present invention, and being comparatively smaller scale to dimples formed by a conventional surface treatment method to form dimples on a mold surface, any irregularities formed on the surfaces of transparent resin molded articles by transfer from the dimples are also small and shallow. When forming such small and shallow dimples, the amount of the base metal of the mold pushed out by plastic flow arising during bombardment with the ejection particles is lessened, such that projections are not formed at peripheral edge portions of the dimples, or such that even if projections are formed, they do not have a raised shape. It is thought that transparency can be imparted to the transparent resin molded articles obtained even though dimples are formed on the mold surface due to the absence of irregularities formed by transfer from such projections, and due to the absence of scratches formed by such projections scratching the surface of transparent resin molded articles.

Moreover, a mold subjected to the surface treatment method of the present invention was confirmed to obtain a great improvement in demoldability and an improvement in durability compared to a polished object.

Reasons for such an improvement in demoldability are thought to be as follows. There is an improvement in demoldability obtained by release agent being retained, or air being retained, in the dimples, similarly to in a conventional surface treatment method in which dimples formed on a mold surface, thereby reducing the contact surface area between the molding material and the mold surface. However, in addition, the ability to retain release agent and to retain air in the dimples is improved by the larger reaction force resulting from the larger surface pressure acting at the dimples due to the dimples formed being small and shallow, thereby improving demoldability. Moreover, one cause of improved demoldability is thought to be a reduction in resistance to extraction when demolding due to not forming projections with a raised shape.

Moreover, ejection particles that have a comparatively small particle diameter, i.e. a median diameter from 1 μm to 20 μm, are employed as the spherical ejection particles to form the comparatively small dimples as described above. The surface-hardness after treatment is therefor raised compared to a conventional surface treatment method employing ejection particles having a larger particle diameter, and this is also thought to be a contributing factor to the greatly improved demoldability obtained.

It is known that when shot peening is performed by ejecting shot so as to bombard the surface of a metal product to be treated, hardness rises and the surface structure of the workpiece is miniatualized. The rise in the surface hardness of a mold according to this principle is thought to be something that is not only obtained by the surface treatment method of the present invention, but is also similarly obtained by a conventional method of treating a surface of a mold in which treatment is performed by ejecting spherical ejection particles at a mold surface.

However, tests performed to measure the surface hardness of treated objects after performing treatment in which ejection particles of different particle diameters are ejected against the surface of a mold confirm that, within a comparatively low ejection pressure range, a higher rise in hardness is obtained when ejection particles with a smaller particle diameters are employed.

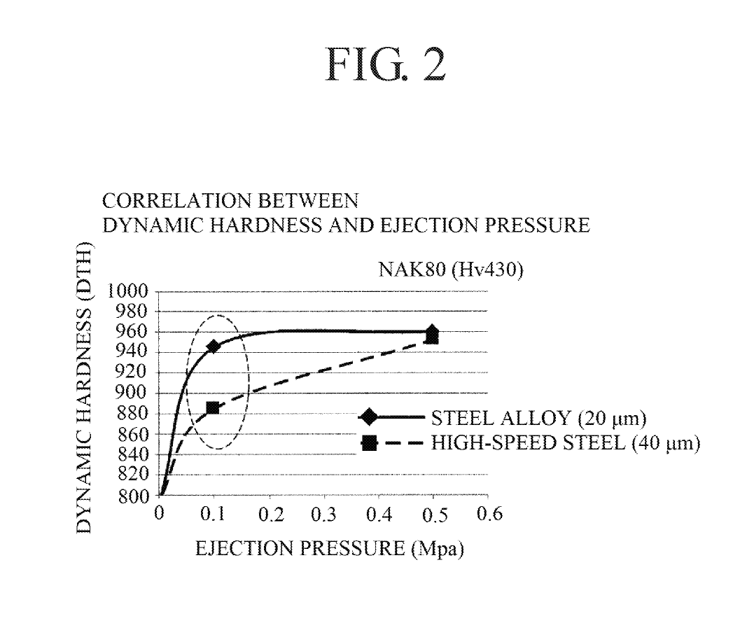

FIG. 2 is a diagram illustrating the results of performing the above tests on a mold manufactured from NAK 80 (Hv 430). In a range of ejection pressures up to 0.5 MPa, the dynamic hardness of the mold surface was found to be raised more when ejection particles (material: steel alloy) with a median diameter of 20 μm were ejected (see the solid line in FIG. 2) than when ejection particles (material: high-speed steel) with a median diameter of 40 μm were ejected (see the dashed line in FIG. 2).

Different effects arise in this manner from the differences of particle diameters of the ejection particles employed. When ejection particles having a small particle diameter are used, the flight speed of the ejection particles is raised, raising the bombardment energy when the mold surface is bombarded, which raises the bombardment energy per unit surface area at the bombarded positions. This is thought to result in a higher forging effect being obtained even when ejecting with a low pressure compressed gas. Abrasion and deformation of the dimples formed on the mold surface is not liable to occur due to obtaining such an increase in hardness. As a result, ideal diameters and depths can be maintained over a long period of time, such that the advantageous effects achieved by the surface treatment method of the present invention, i.e. imparting transparency, improving demoldability, and the like, can be maintained over a long period of time.

Note that reference to “dynamic hardness” means a hardness obtained from an indentation depth at a test force in a process to indent a triangular pyramidal indenter, and the dynamic hardness can be found for a test force P (mN) and an indentation depth D of an indentor (μm) by the following formula.

DH=α×P÷(D²)

Herein, α is an indenter shape coefficient. In the measurements described above, a Shimadzu Dynamic Ultra Micro Hardness Tester DUH-W201 (manufactured by Shimadzu Corporation) was employed, and α was measured at 3.8584 when a 115° triangular pyramidal indenter was employed.

### Examples

A description follows regarding imparting transparency to resin molded articles, and to the content of tests performed to derive the formation conditions (diameter and depth) needed for dimples in order to improve the demoldability of a mold.

(1) Test Objective

The test is performed in order to find formation conditions (diameter and depth) of dimples capable of imparting transparency to resin molded articles and capable of improving demoldability of molds.

(2) Test Method

(2-1) Summary

Dimples were formed on plural types of molds made from base materials which are respectively different, while employing varying combinations of material and particle diameter of the ejection particles employed and the ejection method (ejection apparatus, ejection pressure, etc.). The diameter and depth of the dimples formed was then measured.

After forming the dimples, molding with transparent resin was performed using each of the molds. The transparency was then compared by visual inspection to that of transparent resin molded articles molded by molds whose surfaces had been finished smooth by polishing (referred to below as “polished objects”). Molds giving a transparency inferior to that from polished objects were evaluated as “X”, and molds giving a transparency equivalent to that from polished objects were evaluated “O”.

A comparison of demoldability was also performed. Molds having a demoldability equivalent or inferior to that of polished objects were evaluated as “X”, and molds having a demoldability surpassing that of polished objects were evaluated as “O”.

A range of diameters and depths of dimples capable of imparting transparency to resin molded articles obtained was derived from the results of the above tests.

(2-2) Types of Mold and Treatment Conditions

The materials of molds to be treated and the treatment conditions for the surface treatment performed on each of the molds are listed in Table 1 and Table 2, below.

TABLE 1
Type of Mold and Mold Treatment Conditions 1

| | Spherical Ejection Particles | | | | | | | | |
|---|---|---|---|---|---|---|---|---|---|
| | Particle | | | Ejection Conditions | | | | Mold | |
| | Diameter | | Hard- | | Ejection | Nozzle | Ejection | | Hard- |
| Sample | D⁵⁰ | | ness | Ejection | Pressure | Diameter | Duration | Base Metal | ness |
| No. | (μm) | Material | (Hv) | Method | (MPa) | (mm) | (sec) | (Type) | (Hv) |
| 1 | 21 | steel | 870 | FD | 0.5 | 5 | 1800 | “STAVAX” | 630 |
| | | alloy | | | | | | (cavity) | |
| 2 | 80 | high- | 840 | FD | 0.5 | 5 | 1800 | | |
| | | speed | | | | | | | |
| | | steel | | | | | | | |
| 3 | 13 | steel | 870 | FD | 0.2 | 5 | 360 | | |
| | | alloy | | | | | | | |
| 4 | 36 | high- | 840 | FD | 0.2 | 5 | 360 | | |
| | | speed | | | | | | | |
| | | steel | | | | | | | |
| 5 | 17 | steel | 870 | SF | 0.5 | 7 | 30 | S50C | 194 |
| | | alloy | | | | | | (core pin) | |
| 6 | 20 | alumina | 1800 | FD | 0.3 | 5 | 30 | | |
| 7 | 64 | high- | 840 | SF | 0.5 | 7 | 30 | | |
| | | speed | | | | | | | |
| | | steel | | | | | | | |
| 8 | 15 | steel | 870 | SF | 0.1 | 7 | 30 | | |
| | | alloy | | | | | | | |
| 9 | 20 | zircon | 700 | LD | 0.05 | 9 | 30 | | |
| 10 | 80 | high- | 840 | SF | 0.1 | 7 | 30 | | |
| | | speed | | | | | | | |
| | | steel | | | | | | | |

TABLE 2
Type of Mold and Mold Treatment Conditions 2

| | Spherical Ejection Particles | | | | | | | | |
|---|---|---|---|---|---|---|---|---|---|
| | Particle | | | Ejection Conditions | | | | Mold | |
| | Diameter | | Hard- | | Ejection | Nozzle | Ejection | | Hard- |
| Sample | D⁵⁰ | | ness | Ejection | Pressure | Diameter | Duration | Base Metal | ness |
| No. | (μm) | Material | (Hv) | Method | (MPa) | (mm) | (sec) | (Type) | (Hv) |
| 11 | 12 | steel | 870 | SF | 0.2 | 7 | 30 | S55C | 270 |
| | | alloy | | | | | | (mold for | |
| 12 | 20 | zircon | 700 | FD | 0.3 | 5 | 30 | rubber) | |
| 13 | 15 | high- | 840 | LD | 0.01 | 9 | 30 | | |
| | | speed | | | | | | | |
| | | steel | | | | | | | |
| 14 | 63 | alumina | 1800 | SF | 0.2 | 7 | 30 | | |
| 15 | 4 | zircon | 700 | SF | 0.5 | 7 | 30 | NAK80 | 420 |
| 16 | 20 | steel | 870 | FD | 0.3 | 5 | 30 | (mold for | |
| | | alloy | | | | | | acrylic) | |
| 17 | 8 | alumina | 1800 | LD | 0.02 | 9 | 30 | | |
| 18 | 80 | high- | 840 | SF | 0.2 | 7 | 30 | | |
| | | speed | | | | | | | |
| | | steel | | | | | | | |
| 19 | 8 | high- | 840 | SF | 0.2 | 7 | 30 | A7075 | 183 |
| | | speed | | | | | | (mold for | |
| | | steel | | | | | | plastic) | |
| 20 | 20 | alumina | 1800 | SF | 0.1 | 7 | 30 | | |
| 21 | 10 | zirconia | 1300 | LD | 0.05 | 9 | 30 | | |
| 22 | 80 | zirconia | 700 | SF | 0.3 | 7 | 30 | | |

*The ejection methods indicated in Table 1 and Table 2 employed the following blasting apparatuses:
SF: Suction Type (“SFK-2” manufactured by Fuji Manufacturing Co., Ltd.)
FD: Direct Pressure Type (“FDQ -2” manufactured by Fuji Manufacturing Co., Ltd.)
LD: Blower Type (“LDQ-2” manufactured by Fuji Manufacturing Co., Ltd.)

Polished objects were prepared for each of the molds for comparison. Note that the surface roughness Ra after polishing was 0.1 μm or less for the “STAVAX” (cavity) and NAK80, 0.2 μm or less for the S50C (core pin), S55C (mold for rubber), and 0.2 μm or less for the A7075 (mold for plastic).

(2-3) Dimple Diameter and Depth Measurement Method

The diameter and depth of the dimples were measured using a profile analyzing laser microscope (“VK-X250” manufactured by Keyence Corporation).

Measurements of the surface of the mold were made directly in cases in which direct measurement was possible. In cases in which direct measurement was not possible, methyl acetate was dripped onto a cellulose acetate film to cause the cellulose acetate film to follow the surface of the mold, and after drying and peeling off the cellulose acetate film, measurement was performed based on the inverted dimples transferred to the cellulose acetate film.

Surface image data imaged by the profile analyzing laser microscope (or, image data inverted from captured images measured by employing the cellulose acetate film) was analyzed using a “Multi-File Analysis Application (VK-H1XM by Keyence Corporation) to perform the measurements.

The “Multi-File Analysis Application” is an application that uses data measured by a laser microscope to measure surface roughness, line roughness, height and width, etc. The application analyzes the equivalent circular diameter, depth, and the like, sets a reference plane, and is capable of performing image processing such as height inversion.

In measuring, first the “image processing” function was used to set the reference plane (however, in cases in which the surface shape is a curved plane, the reference plane is set after the curved plane has been corrected to a flat plane by using plane shape correction). Then, the measurement mode is set to indentation in the “volume/area measurement” function of the application, indentations were measured with respect to the set “reference plane”, and the “average depth” in the indentation measurement results and the average value of the results for “equivalent circular diameter” were taken as the depth and equivalent diameter of the dimples.

Note that the reference plane described above was computed from height data using a least squares method.

Moreover, the “equivalent circular diameter” and the “equivalent diameter” described above are measured as the diameter of a circle determined by converting the projected surface area measured for an indentation (dimple) into a circular projected surface area.

Note that the “reference plane” described above indicates a flat plane at the origin (reference) measurement for height data, and is employed mainly to measure depth, height, etc. in the vertical direction.

(3) Measurement Results

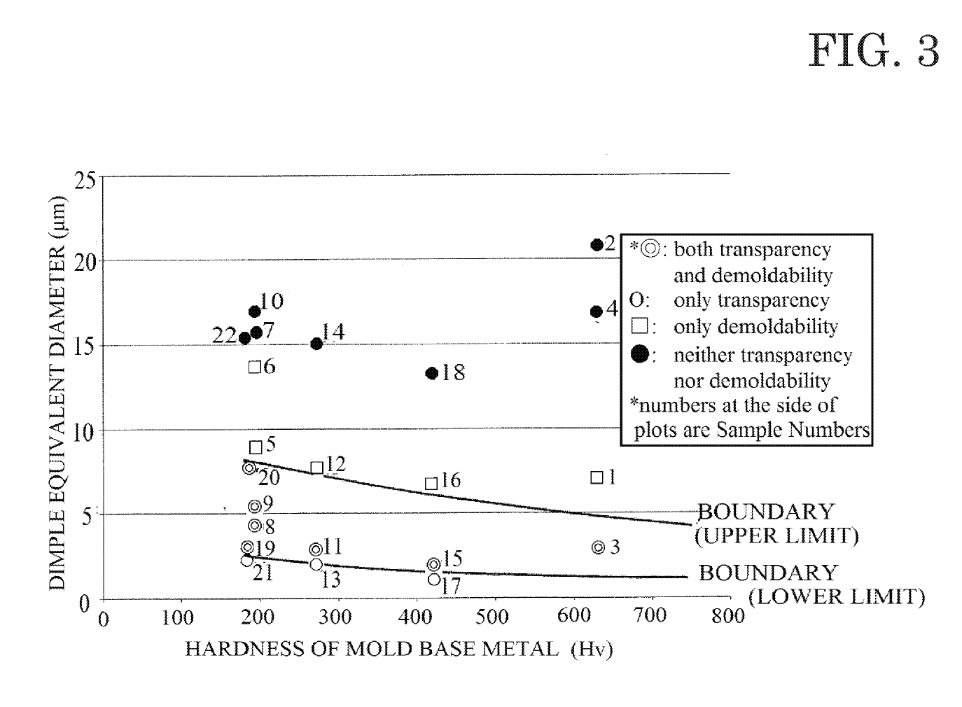

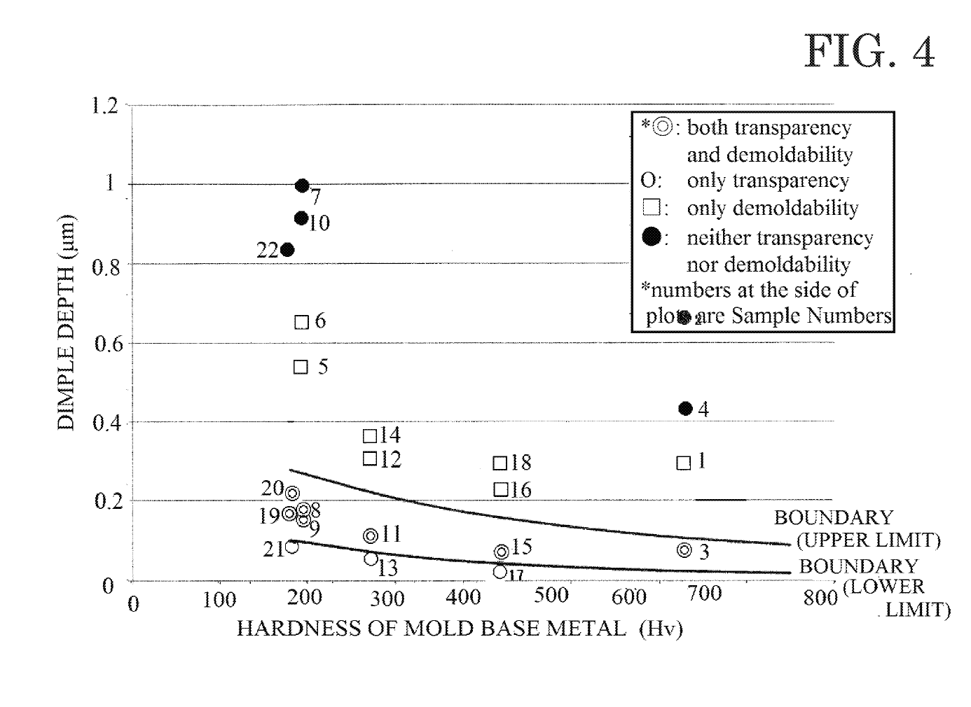

The measurement results for each of the Samples with regards to dimple diameter and dimple depth and the evaluation results for transparency and demoldability are listed in Table 3 and Table 4. FIG. 3 is a scatter plot illustrating dimple diameter against hardness of mold base metal for all Samples, and FIG. 4 is a scatter plot illustrating dimple depth against hardness of mold base metal for all Samples.

TABLE 3
Measurement Results for Equivalent Diameter and Depth of Dimples, and
Transparency and Demoldability Evaluation Results 1

| | | | Dimple | | | |
|---|---|---|---|---|---|---|
| | | | Equivalent | Dimple | | |
| | Sample | Molding | Diameter | Depth | Transparency | Demoldability |
| Mold | No. | Material | (μm) | (μm) | Evaluation | Evaluation |
| “STAVAX” | 1 | Poly- | 6.94 | 0.30 | X | O |
| (cavity) | 2 | carbonate | 20.72 | 0.66 | X | X |
| | 3 | | 2.92 | 0.08 | O | O |
| | 4 | | 16.85 | 0.43 | X | X |
| S50C | 5 | PVC | 8.52 | 0.54 | X | O |
| (core pin) | 6 | (polyvinyl- | 13.72 | 0.66 | X | O |
| | 7 | chloride) | 15.76 | 0.99 | X | X |
| | 8 | | 4.39 | 0.18 | O | O |
| | 9 | | 5.30 | 0.16 | O | O |
| | 10 | | 16.88 | 0.91 | X | X |

* Evaluations of transparency indicate:
O: Molds giving a transparency equivalent to that of polished objects
X: Molds giving a transparency inferior to that of polished objects
* Evaluations of demoldability indicate:
O: demoldability exceeding that of polished objects
X: demoldability the same as or worse than that of polished objects

TABLE 4
Measurement Results for Equivalent Diameter and Depth of Dimples, and
Transparency and Demoldability Evaluation Results 2

| | | | Dimple | | | |
|---|---|---|---|---|---|---|
| | | | Equivalent | | | |
| | Sample | Molding | Diameter | Dimple | Transparency | Demoldability |
| Mold | No. | Material | (μm) | Depth (μm) | Evaluation | Evaluation |
| S55C | 11 | Silicone | 2.91 | 0.11 | O | O |
| (mold for | 12 | rubber | 8.37 | 0.32 | X | O |
| rubber) | 13 | | 2.50 | 0.06 | O | X |
| | 14 | | 14.92 | 0.36 | X | X |
| NAK80 | 15 | Acrylic | 1.98 | 0.06 | O | O |
| (mold for | 16 | | 6.92 | 0.22 | X | O |
| plastic) | 17 | | 1.20 | 0.01 | O | X |
| | 18 | | 13.31 | 0.29 | X | X |
| A7075 | 19 | Poly- | 2.70 | 0.16 | O | O |
| (mold for | 20 | carbonate | 7.53 | 0.22 | O | O |
| plastic) | 21 | | 2.33 | 0.09 | O | X |
| | 22 | | 15.58 | 0.82 | X | X |

* Evaluations of transparency indicate:
O: Molds giving a transparency equivalent to that of polished objects
X: Molds giving a transparency inferior to that of polished objects
* Evaluations of demoldability indicate:
O: demoldability exceeding that of polished objects
X: demoldability the same as or worse than that of polished objects

(4) Interpretation

In the scatter plots illustrated in FIG. 3 and FIG. 4, the numbers appended to the plots indicate the respective sample numbers. In the plots, “⊚” indicates that both transparency and an improvement in demoldability were obtained, “O” indicates that although transparency was obtained, demoldability was not improved, “□” indicates that demoldability was improved, but transparency was not obtained, “●” indicates that neither transparency nor an improvement in demoldability was obtained.

As is apparent from the scatter plots illustrated in FIG. 3 and FIG. 4, for both the diameter and depth of the dimples, it was found that the Samples that were able to impart transparency were concentrated at the lower side of the scatter plots, and the Samples that were not able to impart transparency were concentrated at the upper side of the scatter plots. Thus, it was confirmed that making both the diameter and the depth smaller for the dimples formed resulted in transparency being obtained.

The curves labeled “boundary (upper limit)” in the scatter plots of FIG. 3 and FIG. 4 are curves fitted to the upper limit of the group of Samples for which transparency was obtained. These curves represent approximations to the manner in which the upper limit values of equivalent diameter and depth of dimples that obtained an improvement in transparency change relative to changes in base metal hardness of the mold.

Thus, transparency can be imparted to resin molded articles obtained by employing a mold formed with dimples of a diameter not exceeding an equivalent diameter (W) found from a formula representing the curve “boundary (upper limit)” (W=1.5+8.9e^{-H/630}) illustrated in FIG. 3, which is a scatter plot of dimple equivalent diameter (W) against hardness of mold base metal (H). Furthermore, more preferably, the dimples are formed with a depth not exceeding a depth (D) found from a formula representing the curve “boundary (upper limit)” (D=0.05+0.4e^{-H/320}) illustrated in FIG. 4, which is a scatter plot of dimple depth (D) against hardness of mold base metal (H).

Transparent resin molded articles can be manufactured with molds polished to a mirror finish. Hence, if the only consideration is transparency, then there are no lower limit values to the diameter and depth of dimples to impart transparency.

However, the forming of dimples contributes to improved demoldability, as discussed above, and no improvement in demoldability could be confirmed for dimples formed with small diameter and depth, such as those of Sample 21, Sample 13, and Sample 17, even though transparency was imparted to resin molded articles.

Such a phenomenon is thought to occur because, as the dimples formed get smaller, the surface state of the mold after dimple formation approaches that of a mirror finish.

The curves labeled “boundary (lower limit)” in the scatter plots of FIG. 3 and FIG. 4 are curves fitted to the boundary between the group of Samples for which an improvement in demoldability was confirmed, and the group of Samples for which no improvement in demoldability was confirmed. These curves represent approximations to the manner in which the lower limit values of diameter and depth of dimples that obtain an improvement in demoldability change relative to changes in base metal hardness of the mold.

Thus, an improvement in demoldability can be obtained by using a mold formed with dimples of a diameter of at least a equivalent diameter (W) found from a formula representing the fitted curve at the lower values (W≥1+3.3e^{-H/230}) illustrated in FIG. 3, which is a scatter plot of the dimple equivalent diameter (W) against hardness of mold base metal (H). Furthermore, more preferably, the dimples are formed with a depth of at least a depth (D) found from a formula representing the fitted curve at the lower values (D≥0.01+0.2e^{-H/230}) illustrated in FIG. 4 which is a scatter plot of dimple depth (D) against hardness of mold base metal (H).

Thus, at the same time as improving demoldability, which is sometimes reduced in molds polished to a mirror finish, transparency is also obtainable by setting a dimple equivalent diameter (W) within a range defined by the following formula:

1+3.3e^{-H/230}≤W≤1.5+8.9e^{-H/630} Formula (1)

and, more preferably, furthermore by setting a dimple depth (D) within a range defined by the following formula:

0.01+0.2e^{-H/230}≤D≤0.05+0.4e^{-H/320} Formula (2)

1. A method of treating a surface of a mold for transparent resin molding, the method comprising:
ejecting substantially spherical ejection particles against a surface of a mold employed to mold a transparent resin so as to bombard the surface; and
forming dimples with an equivalent diameter in a range that satisfies a condition defined by the following formula:
1+3.3e^{-H/230}≤W≤1.5+8.9e^{-H/630} Formula (1)
wherein W is an equivalent diameter (μm) of the dimples and H is a base metal hardness (Hv) of the mold.

2. The surface treatment method of the mold for transparent resin molding according to claim 1, wherein the dimples are formed with a depth in a range satisfying a condition defined by the following formula:
0.01+0.2e^{-H/230}≤D≤0.05+0.4e^{-H/320} Formula (2)
wherein D is a depth (μm) of the dimples and H is a hardness of mold base metal (Hv).

3. The surface treatment method of the mold for transparent resin molding according to claim 1, wherein the dimples are formed by ejecting the ejection particles having a median diameter not greater than 20 μm at an ejection pressure of from 0.01 MPa to 0.6 MPa such that a surface area formed with the dimples is not less than 50% of a surface area of the mold surface.

4. The surface treatment method of the mold for transparent resin molding according to claim 1, wherein the ejection particles are ejected against a surface of a mold having a surface roughness adjusted to an Ra of 0.3 μm or less.

5. A mold for transparent resin molding that has been surface treated with the surface treatment method of the mold for transparent resin molding according to claim 1.

6. A transparent resin molded article molded with a mold that has been surface treated with the surface treatment method of the mold for transparent resin molding according to claim 1.

7. The surface treatment method of the mold for transparent resin molding according to claim 2, wherein the dimples are formed by ejecting the ejection particles having a median diameter not greater than 20 μm at an ejection pressure of from 0.01 MPa to 0.6 MPa such that a surface area formed with the dimples is not less than 50% of a surface area of the mold surface.

8. The surface treatment method of the mold for transparent resin molding according to claim 2, wherein the ejection particles are ejected against a surface of a mold having a surface roughness adjusted to an Ra of 0.3 μm or less.

9. The surface treatment method of the mold for transparent resin molding according to claim 3, wherein the ejection particles are ejected against a surface of a mold having a surface roughness adjusted to an Ra of 0.3 μm or less.

10. A mold for transparent resin molding that has been surface treated with the surface treatment method of the mold for transparent resin molding according to claim 2.

11. A mold for transparent resin molding that has been surface treated with the surface treatment method of the mold for transparent resin molding according to claim 3.

12. A mold for transparent resin molding that has been surface treated with the surface treatment method of the mold for transparent resin molding according to claim 7.

13. A transparent resin molded article molded with a mold that has been surface treated with the surface treatment method of the mold for transparent resin molding according to claim 2.

14. A transparent resin molded article molded with a mold that has been surface treated with the surface treatment method of the mold for transparent resin molding according to claim 3.

15. A transparent resin molded article molded with a mold that has been surface treated with the surface treatment method of the mold for transparent resin molding according to claim 7.
